(19) United States
(12) Patent Application Publication
(10) Pub. No.: US 2007/0120636 A1
(43) Pub. Date: May 31, 2007

(54) Magnetic coupling device for contactless energy transmission systems

(75) Inventors: Wan-Pei Chen, Hsinchu (TW); Mu-Ping Chen, Hsinchu (TW); Po-Shen Chen, Hsinchu (TW); Wen-Nan Huang, Hsinchu (TW); Po-Yen Chen, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/505,346

(22) Filed: Aug. 17, 2006

(30) Foreign Application Priority Data
Nov. 28, 2005 (TW) 94141635

(51) Int. Cl. H01F 17/06

(52) U.S. Cl. 336/178

(57) ABSTRACT

A detachable transformer for contactless power system includes a first magnetic coupling element wound with coil and a second magnetic coupling element wound with coil. The first magnetic coupling element and the second magnetic coupling element are of symmetric shape and arranged in contactless manner to provide contactless power coupling. The first magnetic coupling element and the second magnetic coupling element are designed to have concave portion and convex portion on facing surface thereof. Therefore, the magnetic flux can be confined and the magnetic resistance is reduced to enhance conversion efficiency of the detachable transformer.

### FIELD OF THE INVENTION

The present invention relates to a detachable transformer for a contactless energy transmission system, in particular, the magnetic coupling device structure design of the detachable transformer can decrease leakage magnetic flux and improve electrical energy transmission efficiency.

### DESCRIPTION OF PRIOR ART

The contactless energy transmission system generally utilizes magnetic coupling to transfer the electrical energy from the primary to the secondary by means of magnetism concept. The contactless energy transmission system is extensively used for the charging devices of electric vehicles, electric toothbrushes, portable telephones, the power supplies of automated cranes . . . and so on. FIG. 1 shows a circuit diagram of a prior art contactless energy transmission system, where a detachable transformer is used to separate at least two different power sources. The detachable transformer transmits electrical energy based on the principle of magnetic induction. Therefore, the magnetic coupling effect of the detachable transformer has impact on the electrical energy conversion efficiency for overall system.

There are many types of prior art detachable transformers 1, for example, FIG. 2 shows a detachable transformer with U-type cores 2. The U-type cores 2 are wound with coils 3 to form a primary side and a secondary side. Moreover, the two U-type cores 2 are placed in proximity with a gap therebetween to couple the electrical energy of the primary side to the secondary side. Related researches and analyses show that the magnetic coupling effect of the detachable transformer depends on the air gap. The magnetic coupling efficiency of the detachable transformer is around 80% when the air gap between the primary side and the secondary side is zero. The magnetic coupling efficiency of the detachable transformer is less than 50% when the air gap between the primary side and the secondary side is more than 2 mm.

### SUMMARY OF THE INVENTION

It is the object of the present invention to provide a detachable transformer for a contactless energy transmission system to decrease leakage magnetic flux and improve electrical energy transmission efficiency, where the detachable transformer comprises magnetic coupling element with concave portion and convex portion, respectively. The magnetic coupling element contains a core and windings. The specific slant air gap design has the effect of cover.

Accordingly, the present invention provides a detachable transformer for contactless power system. The detachable transformer contains a first magnetic coupling element comprising a plurality of coupling legs as an opened end, where the first magnetic coupling element being wound with coil to form a primary side. The detachable transformer further contains a second magnetic coupling element comprising a plurality of coupling legs as an opened end. The second magnetic coupling element is wound with coil to form a secondary side. The opened end of the first magnetic coupling element faces the opened end of the second magnetic coupling element in contactless way to provide contactless power coupling. The coupling leg of the first magnetic coupling element comprises at least one bump on a facing surface thereof. The coupling leg of the second magnetic coupling element comprises at least one dent on a facing surface thereof, where wherein the bump can be fit into the dent in contactless manner.

Accordingly, the present invention provides a detachable transformer for contactless power system. The detachable transformer comprises a primary-side core wound with coil and a secondary-side core wound with coil, wherein an electrical power being able to couple to the secondary-side core; wherein at least one concave portion and at least one convex portion are formed on facing surfaces of the primary-side core and the secondary-side core.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a circuit diagram of a prior art contactless energy transmission system.

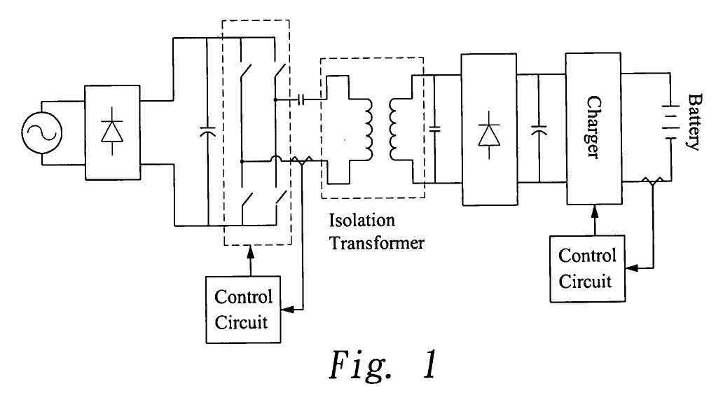

FIG. 2 shows a detachable transformer with U-type cores.

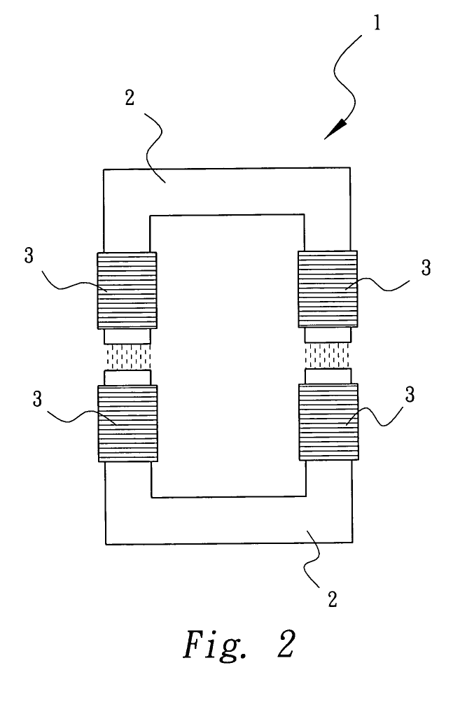

FIG. 3 shows the sectional view of a detachable transformer according to a preferred embodiment of the present invention.

FIGS. 4a and 4b show the magnetic flux in the prior art detachable transformer and the detachable transformer according to a preferred embodiment of the present invention, respectively.

FIG. 5 shows the measurement result by impedance analyzer.

### DETAILED DESCRIPTION OF THE INVENTION

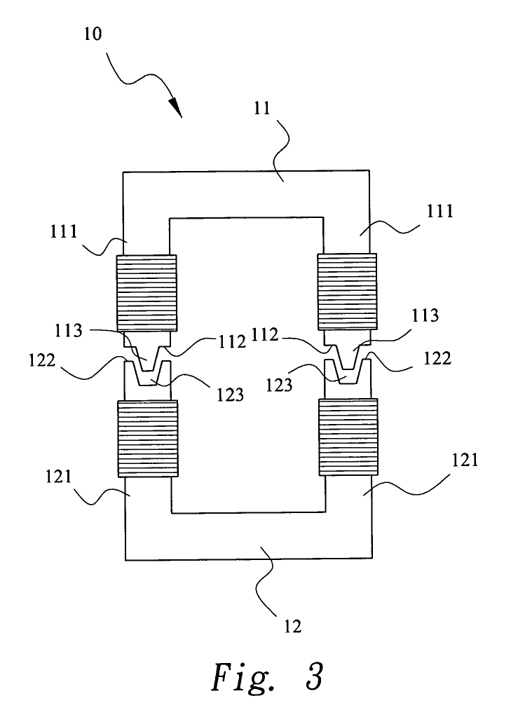

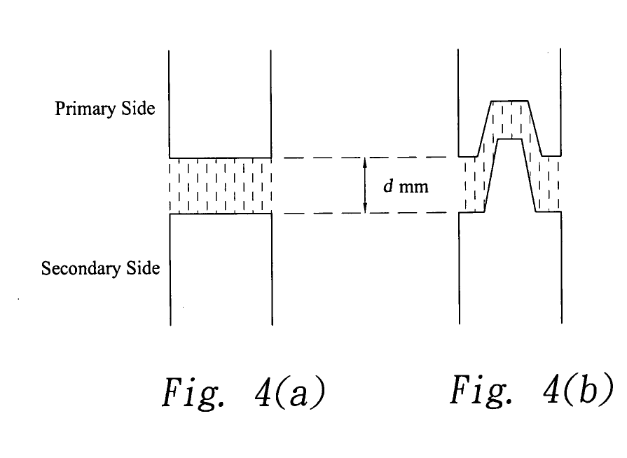

FIG. 3 shows the sectional view of a detachable transformer according to a preferred embodiment of the present invention. The detachable transformer also comprises two cores for magnetic coupling. The two cores are wound with coils to form the primary side and the secondary side. According to the present invention, each core comprises facing surface with concave or convex shapes to form more confined magnetic coupling path and to reduce magnetic loss. FIGS. 4a and 4b show the magnetic flux in the prior art detachable transformer and the detachable transformer according to a preferred embodiment of the present invention, respectively. When the prior art detachable transformer and the detachable transformer according to a preferred embodiment of the present invention have the same air gap (d mm), the magnetic flux area of the detachable transformer according to the present invention is larger than that of the prior art detachable transformer, and part of the magnetic flux path length of the detachable transformer according to the present invention is less than that of the prior art detachable transformer.

With reference again to FIG. 3, the detachable transformer 10 according to the present invention comprises a first core 11 and a second core 12 with a plurality of coupling legs 111 and 121, respectively. The first core 11 and the second core 12 can be of U shape or E shape. The coupling legs 111 and 121 of the first core 11 and the second core 12 are in close proximity and have symmetrical shape to provide contactless magnetic coupling effect.

The coupling leg 111 of the first core 11 comprises a facing surface 112 with at least one bump 113. The coupling leg 121 of the second core 12 comprises a facing surface 122 with at least one dent 123. The bump 113 and the dent 123 have such shapes that the bump 113 can be fit with the dent 123 in contactless way. Therefore, the magnetic coupling path can be more confined.

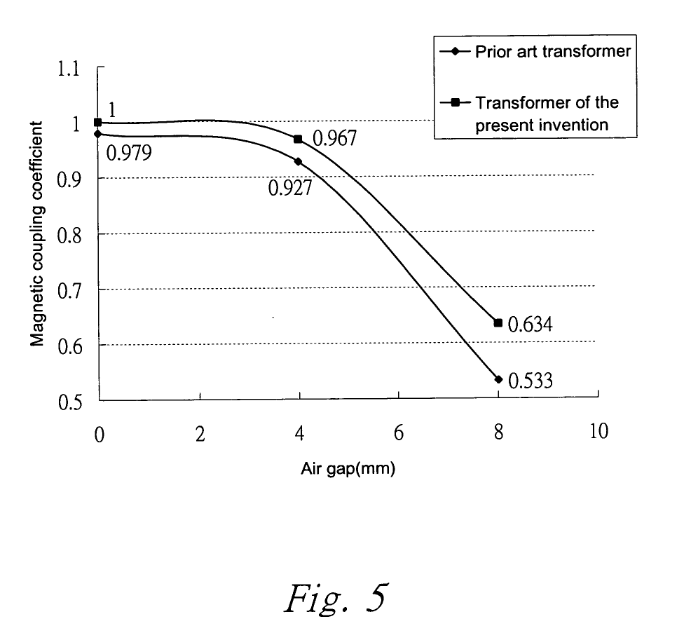

To evaluate the enhancement on the magnetic coupling effect and the reduction on magnetic loss, a test is conducted with following formula for magnetic coupling coefficient:

$$\begin{matrix}L = {L}_{1 p} + {L}_{2 p} + 2 M & ( 1 ) \\ k = \frac{M}{\sqrt{{L}_{1 p} {L}_{2 p}}} & ( 2 )\end{matrix}$$

where k is the magnetic coupling coefficient, L, M, L₁ₚ and L₂ₚ are the total inductance, the mutual inductance, the self inductance of primary side and the self inductance of secondary side. The measurement result by impedance analyzer is shown in FIG. 5. As can be seen from this figure, the magnetic coupling coefficient of the detachable transformer according to the present invention is higher than that of prior art detachable transformer.

As can be verified by simulation and experiment, the core structure according to the present invention can enhance the confinement of magnetic flux and increase coupling efficiency.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A detachable transformer for contactless power system, comprising
a first magnetic coupling element comprising a plurality of coupling legs as an opened end, the first magnetic coupling element being wound with coil to form a primary side;
a second magnetic coupling element comprising a plurality of coupling legs as an opened end, the second magnetic coupling element being wound with coil to form a secondary side; the opened end of the first magnetic coupling element facing the opened end of the second magnetic coupling element in contactless way to provide contactless power coupling;
wherein the coupling leg of the first magnetic coupling element comprises at least one bump on a facing surface thereof, the coupling leg of the second magnetic coupling element comprises at least one dent on a facing surface thereof;
wherein the bump can be fit into the dent in contactless manner.

2. The detachable transformer for contactless power system as in claim 1, wherein the first magnetic coupling element and the second magnetic coupling element are cores.

3. The detachable transformer for contactless power system as in claim 1, wherein the first magnetic coupling element and the second magnetic coupling element are of U shape or E shape.

4. A detachable transformer comprising:
a primary-side core wound with coil and a secondary-side core wound with coil, wherein an electrical power being able to couple to the secondary-side core;
wherein at least one concave portion and at least one convex portion are formed on facing surfaces of the primary-side core and the secondary-side core.

5. The detachable transformer as in claim 4, wherein the primary-side core and the secondary-side core are of symmetric shape with an opening on one side thereof.

6. The detachable transformer as in claim 4, wherein the primary-side core and the secondary-side core are of U shape or E shape.
